(19) United States
(12) Patent Application Publication
(10) Pub. No.: US 2003/0138301 A1
(43) Pub. Date: Jul. 24, 2003

(54) Method for milling fishbone-type notches

(76) Inventor: Hubertus Kuerzel, Olbersdorf (DE)

Correspondence Address: HARNESS, DICKEY & PIERCE, P.L.C., P.O.BOX 8910, RESTON, VA, 20195, US

(21) Appl. No.: 10/311,083

(22) PCT Filed: Jun. 8, 2001
(86) PCT No.: PCT/EP01/06501

(30) Foreign Application Priority Data
Jun. 13, 2000 (EP) 00112530.1

(51) Int. Cl. B23C 5/12; B23C 3/28

(52) U.S. Cl. 407/34; 409/132; 407/40; 407/42; 407/61

(57) ABSTRACT

The invention relates to a method for milling fishbone-type notches (3) which are arranged on the perimeter of a turbine shaft (2) and which are used to receive blade footings. A step-tapered preform (15) of the cross-section (3) of the notch is pre-milled in preferably three machining steps. On the basis of this preform (15), at least the substantial part of the fishbone-type cross-section form which is characterised by undercuts in the step flanks is milled in one tool passage by means of a profile milling cutter (21).

### DESCRIPTION

Method for Milling Fir-Tree Grooves

The invention relates to a method for milling fir-tree grooves, which are used to accommodate blade roots, on the circumference of a turbine shaft. It also relates to a profile milling cutter for carrying out the method.

An axial fir-tree connection is used predominantly in gas and steam turbine engineering to fix turbine blades which are pushed in substantially in the axial direction, in order to optimally absorb long-term loads acting on the blades during operation as a result of centrifugal forces. These centrifugal forces act as static and dynamic bending forces. Securing the blades by means of what are known as fir-tree grooves transmits the forces in a staggered form via a plurality of pairs of teeth. If such fir-tree grooves which are used to secure blades are not curved, but rather are straight, they can most easily be produced by reaming.

However, a drawback of straight fir-tree grooves is the unfavorable introduction of the forces and moments from the projecting exit edge of the profile into the blade root and the relative difficulty of matching the centers of gravity of the blade section and of the blade root on one radius. Securing the blade root in fir-tree grooves in the shape of an arc of a circle provides a suitable remedy to this problem, in particular since the arc shape is close to the shape of the blade. Usually, however, producing fir-tree grooves which are curved in this way without any problems requires special milling machines (“Turbomaschinen im Kraftwerk” [Turbomachines in power plants] by Prof. Dipl.-Ing. Gerhard Schilg, VEB Verlag Technik Berlin, 1st edition, 1978; pp. 247 ff.).

The invention is based on the object of providing a method for producing fir-tree grooves of this type which does not require any special milling machines for this purpose, but rather can be carried out by means of a milling unit which has been placed onto a conventional turbine rotor turning machine. Furthermore, it is intended to provide a milling tool which is particularly suitable for carrying out the method.

With regard to the method, according to the invention this object is achieved by the features of claim 1. For this purpose, first of all a preform of the groove cross section, which tapers in stepped form, is premilled in preferably three machining stages. The main part of the fir-tree cross-sectional shape, which is characterized by undercuts in the step flanks, is milled out of this preform in a single tool pass by means of a profile milling cutter. In this way it is possible to effectively produce in particular curved fir-tree grooves.

The method particularly advantageously makes it possible on the one hand for the load required for the milling operation to be within the capacity of a milling unit of this type. On the other hand, the high machining rate during milling of the undercuts, which are shaped as root hooks, into the step flanks of a preform of the fir-tree cross section, is also managed. This places high demands on the performance of the milling unit if the shaping is to take place substantially in one operation. Hitherto, to manage the high machining rate different tools have been used in a plurality of operations, but the cutting edges of these tools have to be reground undesirably frequently on account of the wear.

With regard to the milling tool for carrying out the method, the invention provides a profile milling cutter having the features of claim 3 which is particularly suitable for producing that part of the fir-tree cross section which is provided with root hooks. The profile milling cutter is preferably provided with carbide disposal tips.

The milling of the cross section of the preform which tapers in stepped form is expediently carried out by means of end mill cutters, which are likewise advantageously provided with carbide disposal tips. A finish-milling operation which may still be required can be carried out using shape finish-milling cutters as hitherto. The tool geometry of these cutters produces the final contour. This is because any allowance with respect to the final contour which may remain after the milling of the root hooks by means of the profile milling cutter is sufficiently small—with respect to the machining rate to be achieved—to protect the machine and tool from damage or destruction.

In a particularly advantageous configuration, the profile milling cutter has a number of cutting tool tips which corresponds to the number of individual grooves which are to be milled for the fir-tree contour, these cutting tool tips being arranged in a uniform distribution and offset over the circumference of the cutter. In this way, it is possible to deal with a particularly high machining rate, since generally only one carbide cutting edge or carbide cutting tool tip per undercut or root hook is acting on the workpiece. This takes into account the limited available spindle power of the milling unit in a particularly advantageous way and, on account of the relatively small number of working steps, in particular also in a time-saving manner, given the relatively high machining rate which is to be achieved.

Exemplary embodiments of the invention are explained in more detail below with reference to drawings, in which:

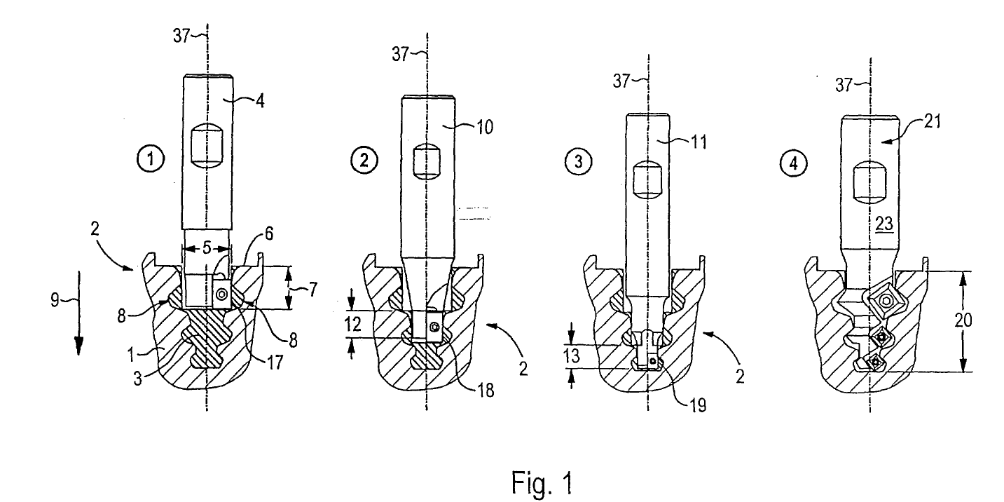

FIG. 1 diagrammatically depicts the sequence of milling firstly a preform of the groove cross section, from which the fir-tree cross-sectional shape is then milled in a single tool pass by means of a specially configured profile milling cutter,

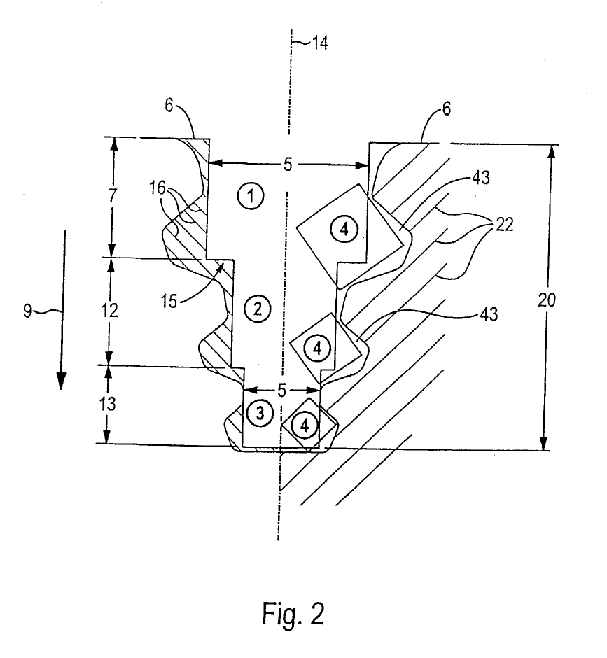

FIG. 2 diagrammatically depicts the result of the method stages which have been passed through in FIG. 1,

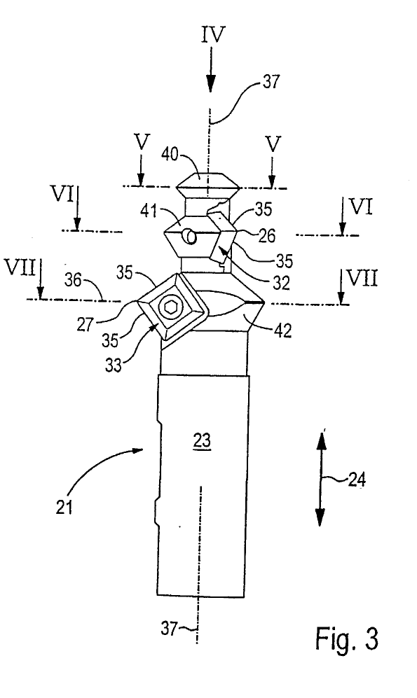

FIG. 3 shows a side view of the profile milling cutter used for what is substantially the last milling stage,

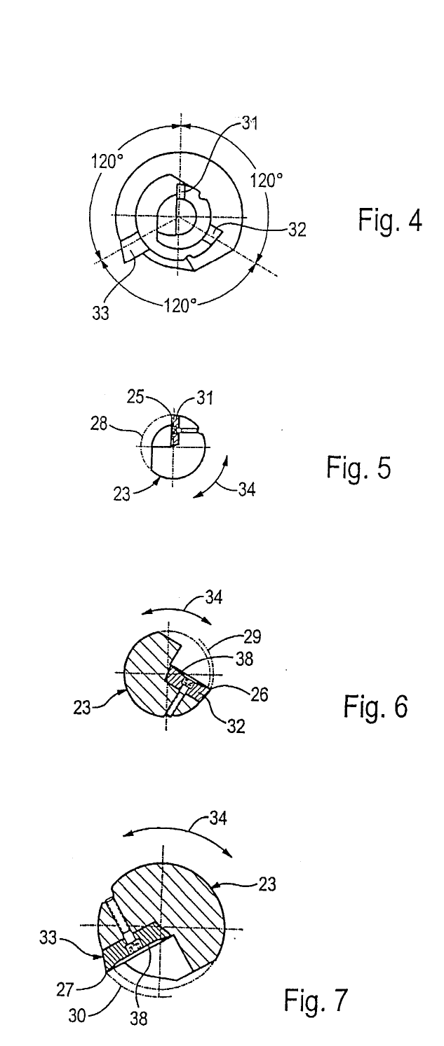

FIG. 4 shows a front view of the profile milling cutter shown in FIG. 3 viewed from the direction indicated by arrow IV in that figure,

FIG. 5 shows a cross-sectional view of the profile milling cutter in section plane V-V from FIG. 3,

FIG. 6 shows a cross-sectional illustration similar to that shown in FIG. 5 corresponding to section plane VI-VI in FIG. 3, and

FIG. 7 shows a cross-sectional illustration similar to those shown in FIGS. 5 and 6, corresponding to section line VII-VII in FIG. 3.

Parts which correspond to one another are provided with identical reference symbols in all the figures.

A fir-tree groove 3, the definitive cross-sectional shape of which is hatched with a greater density of lines in FIG. 1, is to be milled into the circumferential region 1 of a turbine shaft 2, the longitudinal axis of which runs approximately perpendicular to the plane of the illustration shown in FIG. 1 and FIG. 2. This milling takes place in stepwise form, initially so as to produce a preform of the groove cross section, which tapers in stepped form in the radial penetration direction 9, in three method stages (1)-(3) indicated by numbers in circles. In method stage (1), an end mill cutter 4 of relatively large operative diameter 5, starting from a prefabricated support region 6 for the blade root, mills inward—based on the axis of the turbine shaft—over a penetration depth 7. In this way, first of all a preform for the outer root hooks 8, which are subsequently to be milled out on both sides, of the fir-tree groove 3 is created in the outer circumferential region 1.

The further milling operations which follow in the radial penetration direction 9 and are carried out by means of the end mill cutters 10 and 11 for production of the complete preform 15 of the fir-tree cross section follow in the method stages (2) and (3) indicated by numbers in circles. In method stage (2) of FIG. 1, the end mill cutter 10 shapes the penetration region 12, and the end mill cutter 11 shapes a penetration region 13 of smaller internal diameter 14. The intermediate result created by the three milling operations (1) to (3) is a preform 15 of the fir-tree groove 3 which tapers in stepped form in three stages in the radial penetration direction 9. The cross section of this preform 15 of the fir-tree groove 3, which tapers in stepped form in the radial penetration direction 9 starting from the support region 6 for the blade root, is illustrated in FIG. 2 on the left-hand side of the axis of symmetry 14. This cross section is illustrated in the left-hand part of FIG. 2 by hatching 16 which runs from the top left to the bottom right.

The end mill cutters 4, 10 and 11, which are provided with different operative diameters 5, bear, in their active milling circumferential region, carbide cutting edges 17, 18, 19 which are each part of a carbide cutting tool tip, in particular of a disposal cutting tool tip.

In a subsequent method stage (4) (FIGS. 1, 2), the main part of the fir-tree cross-sectional shape 3 is milled from the preform 15 over the entire penetration depth 20 of the profile milling cutter 21 in a single tool pass. The flank region 43 of the definitive cross-sectional shape of the fir-tree groove 3 is illustrated in FIG. 2 to the right of the axis of symmetry 14 and to the left of the hatching lines 22.

The following part of the description of the figures deals with the structural design of the profile milling cutter 21 for the majority of the final shaping of the fir-tree groove 3 from the preform 15 in a method stage (4). On the circumferential side, the milling cutter base body 23 of the profile milling cutter 21 is provided with a number of cutting points 25, 26, 27 which are arranged offset in the axial direction 24 of the milling cutter base body 23, radially project with respect to the milling cutter axis of rotation 37 and are stepped in terms of their operative diameters 28, 29, 30 (FIGS. 5 to 7). Each cutting point 25 to 27 is part of a carbide cutting tool tip 31, 32 or 33 which is exchangeably fixed to the milling cutter base body 23. The cutting tool tips 31 to 33 are disposal cutting tool tips. Each operative diameter 28 to 30 is assigned just one cutting tool tip 31 to 33 on the circumference of the milling cutter base body 23. The cutting point 25 to 27 of each disposal cutting tool tip 31 to 33 projects circumferentially beyond the shank region of the milling cutter base body 23 which supports them.

An important feature is considered to reside in the fact that cutting tool tips 31 to 33 which are provided with different operative diameters 28 to 30 are arranged offset in the circumferential direction 34 with respect to one another on the milling cutter base body 23. They are in each case arranged offset by 120° with respect to one another (FIGS. 5 to 7). This offset in the positioning of the cutting tool tips 31 to 33, which is present in the circumferential direction with respect to the milling cutter axis of rotation 36, makes the profile milling cutter 21 work more uniformly. The cutting tool tips 31, 32, 33, which are each positioned individually on its circumference, do not simultaneously come into contact in each case with the flanks of the preform 15 of the fir-tree groove 3. Rather, they do so in succession at temporal intervals. This avoids load peaks and reduces the maximum drive power 21 which the milling drive is required to produce.

The cutting edges 35 which between them enclose the cutting points 25-27 form approximately a right angle with one another, as can be seen particularly clearly from the shape of the cutting tool tip 33 in FIG. 3. The angle bisector 36 (FIG. 3) between the two cutting edges 35 of a cutting point 25-27 forms approximately a right angle with the milling cutter axis of rotation 37.

The disposable tips 31 to 33 have a square contour. The sides of the square formed by the cutting edges 35 are the tip covering surfaces, and in each case the outer tip covering surface forms or includes the tool face of a cutting edge 35.

Each cutting tool tip 31 to 33 is a perforated disposable tip with a central securing hole, the hole axis of which is oriented approximately perpendicular to the tip covering surfaces 38 of the disposable tip 31 to 33.

Beads 40, 41, 42, which are in each case shaped approximately in the form of an arc segment, are formed on the circumference of the milling cutter base body 23 in order to receive and support the cutting tool tips 31 to 33.

The final shape of the fir-tree cross section (right-hand part of FIG. 2) is milled in substantially one tool pass from the preform 15 in an advantageously time-saving way by means of the profile milling cutter 21. If this cannot be achieved completely, the final shape is produced using separate milling tools in further passes. However, this only requires a small volume of material to be removed, with a low demand on power from the milling unit and with a correspondingly low level of tool wear.

1. A method for milling fir-tree grooves (3) on the circumference of a turbine shaft (2) for receiving blade roots, in which a preform (15) of the groove cross section (3), which tapers in stepped form in the radial penetration direction (9), on the flank sides, in a plurality of machining stages, in particular in three stages, is premilled, and the main part of the fir-tree cross-sectional shape (3), which is characterized by undercuts in the step flanks, is milled out of this preform (15) in one tool pass by means of a profile milling cutter (21).

2. The method as claimed in claim 1, in which the preform (15) is milled in a stepwise manner by end mill cutters (4, 10, 11) which are provided with carbide cutting edges (17-19).

3. A profile milling cutter (21) for carrying out the method as claimed in claim 1 or 2, characterized by a number of cutting points (25 to 27) which are provided on the circumferential side, are arranged axially (24) offset with respect to one another and are stepped in terms of their operative diameters (28 to 30).

4. The profile milling cutter as claimed in claim 3, characterized in that each cutting point (25 to 27) is formed by an exchangeable carbide cutting tool tip (31 to 33).

5. The profile milling cutter as claimed in claim 3 or 4, characterized in that the cutting tool tip (31 to 33) is a disposal cutting tool tip.

6. The profile milling cutter as claimed in one of claims 3 to 5, characterized in that each step in the operative diameter (28 to 30) is assigned only one disposal cutting tool tip (31 to 33) over the entire circumference of the milling cutter.

7. The profile milling cutter as claimed in claim 5 or 6, characterized in that the disposable cutting tool tip (31 to 33) projects circumferentially beyond the shank of a milling cutter base body (23) by way of a cutting point (25 to 27).

8. The profile milling cutter as claimed in one of claims 3 to 7, characterized in that cutting tool tips (31 to 33) which are assigned to different operative diameters (28 to 30) are arranged on the milling cutter base body (23) in such a manner that they are offset in the circumferential direction (34) with respect to one another.

9. The profile milling cutter as claimed in claim 8, characterized in that the cutting tool tips (31 to 33) are offset with respect to one another by the same fraction of 360°.

10. The profile milling cutter as claimed in one of claims 3 to 9, characterized in that the cutting edges (35) which flank the cutting point (25 to 27) of a cutting tool tip (31 to 33) approximately form a right angle with one another.

11. The profile milling cutter as claimed in claim 10, characterized in that the angle bisector (36) between the two cutting edges (35) of a cutting point (25 to 27) approximately forms a right angle with the axis of rotation (27) of the milling cutter.

12. The profile milling cutter as claimed in claim 10 or 11, characterized in that the cutting tool tip (31 to 33) has a square contour, the sides of the square which are covered by the cutting edges (35) forming the tip covering surfaces (38) and one of the tip covering surfaces (38) forming the tool face.

13. The profile milling cutter as claimed in one of claims 3 to 9, characterized in that the cutting tool tip (31 to 33) is a perforated disposal tip with a central securing hole, the hole axis of which is oriented approximately perpendicular to the covering surface (38) of the cutting tool tip (31 to 33).

14. The profile milling cutter as claimed in one of claims 3 to 13, characterized by beads (40 to 42), which are arranged offset with respect to one another and are each formed on the circumference of the milling cutter base body (23) approximately in the form of a ring segment, for receiving and supporting the disposal tips (31 to 33).
